(19) United States
(12) Patent Application Publication
(10) Pub. No.: US 2026/0009680 A1
(43) Pub. Date: Jan. 8, 2026

(54) TEMPERATURE SENSOR

(71) Applicant: Futaba Corporation, Chiba (JP)

(72) Inventor: Takashi INOUE, Chiba (JP)

(73) Assignee: Futaba Corporation, Chiba (JP)

(21) Appl. No.: 19/106,312

(22) PCT Filed: Aug. 31, 2023
(86) PCT No.: PCT/JP2023/031751

§ 371 Date: Feb. 25, 2025

(30) Foreign Application Priority Data
Sep. 21, 2022 (JP) 2022-150236

(51) Int. Cl. G01J 5/05; B29C 37/00; G01J 5/00; G01J 5/02; G01J 5/04; G01J 5/0821; G01J 5/0875

(52) U.S. Cl. CPC G01J 5/05; G01J 5/0037; G01J 5/0205; G01J 5/048; G01J 5/0821; G01J 5/0875; B29C 37/00; B29C 2037/90

(57) ABSTRACT

A temperature sensor used in a molding machine includes: a tubular fiber probe into which an optical fiber is threaded; an outer casing having a shaft into which the fiber probe is inserted; a protective window that is located on a distal end side of the fiber probe and is formed of glass; and a spacer that is disposed between the fiber probe and the protective window and has a space section both sides of which are in contact with the fiber probe and the protective window. The space section has a transmission hole formed to serve as a path leading infrared light to the optical fiber, and a diameter of the transmission hole is equal to or greater than an outer diameter of the optical fiber.

### TECHNICAL FIELD

The present invention relates to the technical field of temperature sensors that are used in molding machines and that use optical fibers.

### BACKGROUND ART

Molding machines that mold resin molded products are provided with sensors to measure the temperature and pressure of resin in cavities or the like. As such sensors, for example, there has been known a temperature sensor in which a fiber probe into which an optical fiber for measuring the temperature of a molten resin filled in a cavity is threaded communicates with the cavity to transmit infrared light emitted from the molten resin to a detector through the optical fiber (see, for example, Patent Document 1).

Meanwhile, some of the temperature sensors as described above are provided with a protective window that covers an incident surface at a distal end portion for the purpose of preventing contamination of the incident surface of the optical fiber and protecting the optical fiber (see, for example, Patent Document 2). For the temperature sensor that is provided with such a protective window, the protective window is formed of a transparent material, allowing infrared light to pass through the protective window and enter the optical fiber from the incident surface.

### PRIOR ART DOCUMENTS

### Patent Documents

Patent Document 1: Japanese Unexamined Patent Application Publication No. 2008-232753
Patent Document 2: Japanese Unexamined Patent Application Publication No. S62-172228

### SUMMARY OF THE INVENTION

### Problems to Be Solved by the Invention

In the meantime, for the temperature sensor that is provided with the protective window as described above, since infrared light passes through the protective window and enters the optical fiber, when an air layer exists between the protective window and the incident surface, the light may be reflected at an interface between the protective window and the air layer or an interface between the air layer and the incident surface depending on the conditions of the air layer or the like, which may cause optical interference.

In particular, since the protective window, the distal end portion of the optical fiber, and the like are exposed to a high-temperature environment, for example, when the thickness of the air layer changes due to the thermal expansion of the protective window or the like, the degree of optical interference may also change, affecting the measurement results obtained by the temperature sensor.

Therefore, an object of the present invention is to ensure stable measurement by suppressing the occurrence of optical interference.

### Means for Solving the Problems

A temperature sensor according to the present invention is a temperature sensor used in a molding machine. The temperature sensor includes: a tubular fiber probe into which an optical fiber is threaded; an outer casing having a shaft into which the fiber probe is inserted; a protective window that is located on a distal end side of the fiber probe and is formed of glass; and a spacer that is disposed between the fiber probe and the protective window and has a space section both sides of which are in contact with the fiber probe and the protective window. The space section has a transmission hole formed to serve as a path leading infrared light to the optical fiber, and a diameter of the transmission hole is equal to or greater than an outer diameter of the optical fiber.

This allows infrared light to pass through the transmission hole of the spacer from the protective window and enter the optical fiber in a state where the space section of the spacer is disposed between the fiber probe and the protective window.

### Effects of the Invention

According to the present invention, since infrared light passes through the transmission hole of the spacer from the protective window and enters the optical fiber in the state where the space section of the spacer is disposed between the fiber probe and the protective window, a certain distance or more can be maintained between the optical fiber and the protective window by means of the space section to ensure stable measurement by suppressing the occurrence of optical interference.

### BRIEF DESCRIPTION OF DRAWINGS

FIG. 1 illustrates an embodiment of the present invention together with FIG. 2 and FIG. 3, and this figure is a cross-sectional view of a temperature sensor.

FIG. 2 is an enlarged cross-sectional view illustrating a part of the temperature sensor.

FIG. 3 is an enlarged cross-sectional view illustrating an example in which a spacer includes only a space section.

### MODES FOR CARRYING OUT THE INVENTION

The following describes an embodiment of a temperature sensor of the present invention with reference to the accompanying drawings.

Note that the temperature sensor described below has a tubular fiber probe, and in the following description, the axial direction of the fiber probe is referred to as the up-and-down direction, and the distal end side of the fiber probe is referred to as the downward direction to show the up, down, left, and right directions. However, the up, down, left, and right directions described below are for convenience of explanation and are not limited to these directions with respect to the implementation of the present invention.

### Configuration of Temperature Sensor

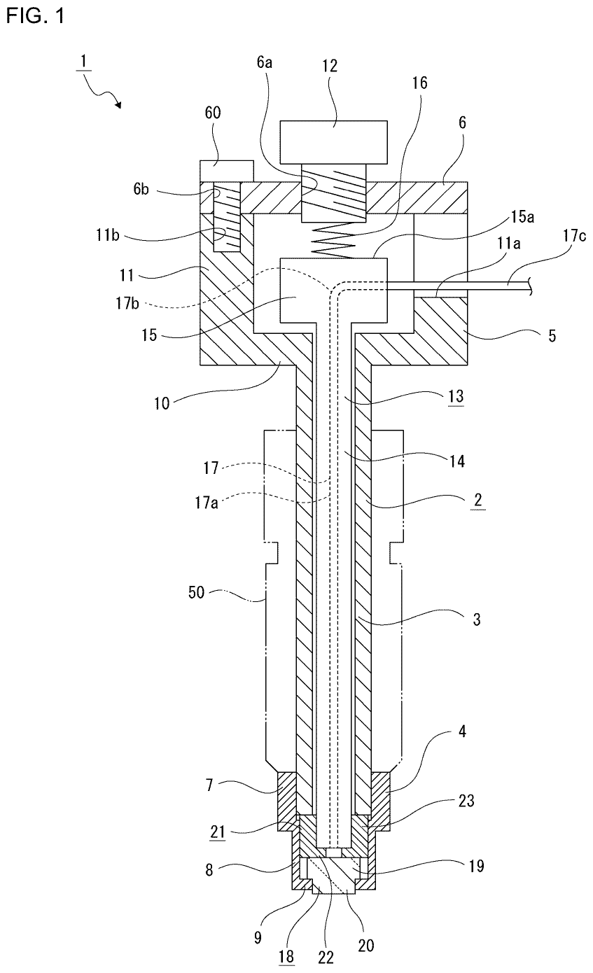

First, the configuration of the temperature sensor is described (see FIG. 1 through FIG. 3).

A temperature sensor 1 is mounted on an injection molding machine (not illustrated) and used, for example, to measure the temperature of a molten resin in an injection unit. Note that the molding machine on which the temperature sensor 1 is mounted is not limited to the injection molding machine, and the temperature sensor 1 may be mounted on an extrusion molding machine, a blow molding machine, or the like.

The temperature sensor 1 has an outer casing 2 that protects each section and the necessary sections that are protected by the outer casing 2 (see FIG. 1).

The outer casing 2 has a shaft 3, a window supporting section 4, a disposing section 5, and a lid section 6. The outer casing 2 is formed of, for example, a metallic material in every section.

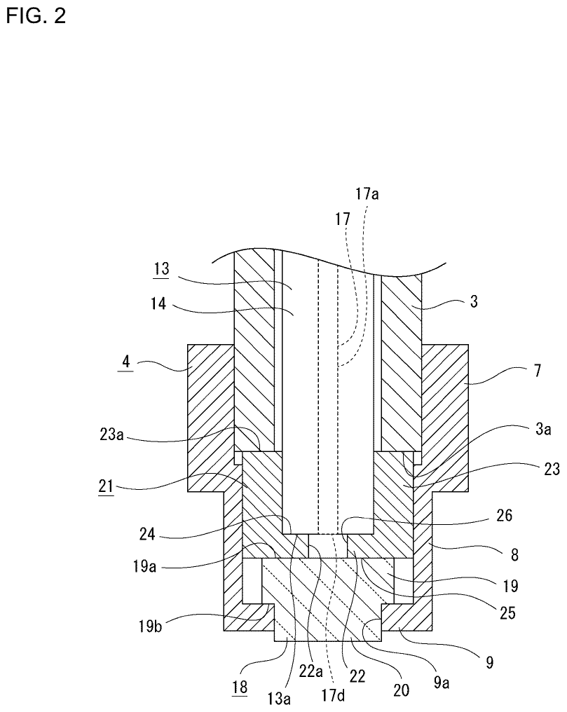

The shaft 3 is formed in a cylindrical shape with its axial direction in the up-and-down direction. A mounting nut 50 for mounting the temperature sensor 1 on the injection molding machine is fitted on a portion of the shaft 3 except for both upper and lower end portions. A lower end surface of the shaft 3 is formed as a pressing surface 3a (see FIG. 1 and FIG. 2).

The window supporting section 4 is formed in a tubular shape with its axial direction in the up-and-down direction and includes a fitting section 7, a holding section 8, and a receiving section 9. Both the fitting section 7 and the holding section 8 are formed in a cylindrical shape, and the diameter of the fitting section 7 is greater than the diameter of the holding section 8. However, the diameter of the fitting section 7 and the diameter of the holding section 8 may be equal. The holding section 8 is provided in continuity with a lower end portion of the fitting section 7 on the lower side of the fitting section 7. The receiving section 9 is formed in a flange shape extending inward from a lower end portion of the holding section 8, and an inner space of the receiving section 9 is formed as a threading hole 9a. In the window supporting section 4, the fitting section 7 is externally fitted to a lower end portion of the shaft 3, and the holding section 8 and the receiving section 9 are positioned below the shaft 3.

The disposing section 5 has a flange section 10 extending outward from an upper end portion of the shaft 3 and a ring section 11 having an approximately cylindrical shape that protrudes upward from an outer circumference portion of the flange section 10. The disposing section 5 is, for example, formed integrally with the shaft 3. The ring section 11 has a notch 11a that is open upward and that radially penetrates. A plurality of fitting holes 11b that are open upward and that are spaced out in the circumferential direction are formed in an upper end portion of the ring section 11.

The lid section 6 is formed in a ring shape and has a screw hole 6a in its center. An adjustment screw 12 is screwed into the screw hole 6a. Screw threading holes 6b that penetrate in the up-and-down direction and that are spaced out in the circumferential direction are formed in an outer circumference portion of the lid section 6. The lid section 6 is mounted on the disposing section 5 from the upper side by screwing mounting screws 60 threaded into the screw threading holes 6b into the fitting holes 11b.

A fiber probe 13 is disposed inside the outer casing 2. The fiber probe 13 is formed of, for example, a metallic material and has a cylindrical section 14 with its axial direction in the up-and-down direction and a brim section 15 continuous with an upper end portion of the cylindrical section 14. The outer diameter of the brim section 15 is greater than the outer diameter of the cylindrical section 14. An upper surface of the brim section 15 is formed as a pressurized surface 15a.

In a state where the lid section 6 is mounted on the disposing section 5, an elastic member 16 is disposed between a lower surface of the adjustment screw 12 and the pressurized surface 15a of the fiber probe 13.

As the elastic member 16, for example, a compression coil spring is used. The fiber probe 13 is biased downward by the biasing force of the elastic member 16. Note that a disc spring, a plate spring, or the like may be used as the elastic member 16, and the elastic member 16 may be formed of a rubber material or the like.

In the temperature sensor 1, the biasing force of the elastic member 16 against the fiber probe 13 can be adjusted by rotating the adjustment screw 12 to change its screwed position with respect to the screw hole 6a.

An optical fiber 17 is threaded into and held in the fiber probe 13. The optical fiber 17 has one end section 17a threaded into the cylindrical section 14 and a bent section 17b that is continuous with the one end section 17a and that is bent, for example, at an approximately right angle inside the brim section 15. In the optical fiber 17, a portion between the bent section 17b and another end section is provided as an intermediate section 17c, and the intermediate section 17c is positioned from an outer circumference surface of the brim section 15 to the outside of the fiber probe 13 through the notch 11a. A detector or the like (not illustrated) is connected to the other end section of the optical fiber 17. An end surface (lower end surface) of the one end section 17a of the optical fiber 17 is formed as an incident surface 17d that infrared light enters.

The window supporting section 4 supports a protective window 18.

The protective window 18 is provided with a portion except for its lower end portion formed in a columnar shape as a contact section 19, and the lower end portion is provided as a supported section 20. For the protective window 18, the contact section 19 and the supported section 20 are integrally formed of, for example, sapphire glass.

The contact section 19 has an upper surface formed as a contact surface 19a, and a lower surface at an outer circumference portion formed as a regulated surface 19b. The diameter of the contact section 19 is equal to or greater than the diameter of the fiber probe 13. The supported section 20 is formed in a disc shape whose diameter is slightly smaller than the diameter of the contact section 19.

In the protective window 18, the contact section 19 is disposed inside the window supporting section 4, and the supported section 20 is threaded into the threading hole 9a of the receiving section 9. Therefore, the protective window 18 is made in a state where the regulated surface 19b of the contact section 19 is in contact with an upper surface of the receiving section 9, preventing the protective window 18 from falling out of the window supporting section 4. The supported section 20 has a lower end portion protruding downward from the threading hole 9a. However, the lower end portion of the supported section 20 may not protrude downward from the threading hole 9a.

The window supporting section 4 supports a spacer 21 as well as the protective window 18.

The spacer 21 is formed of a metallic material, such as stainless steel, and is composed by forming a plate-like space section 22 that faces in the up-and-down direction integrally with a tubular section 23 having a cylindrical shape that protrudes upward from an outer circumference portion of the space section 22.

The space section 22 is externally formed in a circular shape, and has a transmission hole 22a formed in its center. The diameter of the transmission hole 22a is equal to or greater than the diameter of the optical fiber 17. The space section 22 has an upper surface formed as a first abutting surface 24, and a lower surface formed as a second abutting surface 25.

The tubular section 23 has an upper end surface (distal end surface) formed as a pressed surface 23a.

In the spacer 21, the first abutting surface 24 of the space section 22 is brought into contact with a distal end surface (lower surface) 13a of the fiber probe 13, and the second abutting surface 25 of the space section 22 is brought into contact with the contact surface 19a of the protective window 18. Since the fiber probe 13 is biased downward by the elastic member 16, the distal end surface 13a is pressed against the first abutting surface 24, and the second abutting surface 25 is pressed against the contact surface 19a. At this time, the center of the transmission hole 22a of the space section 22 is aligned with the center of the optical fiber 17.

The tubular section 23 of the spacer 21 is made in a state where its inner circumference surface is in contact with an outer circumference surface of the fiber probe 13 and in a state where its outer circumference surface is in contact with an inner circumference surface of the holding section 8 of the window supporting section 4, and the pressing surface 3a of the shaft 3 is pressed against the pressed surface 23a.

In this way, the spacer 21 is disposed inside the window supporting section 4 in the state where its outer circumference surface is in contact with the inner circumference surface of the holding section 8, thus ensuring a stable condition of disposition without being shaky with respect to the window supporting section 4. Therefore, the high positional accuracy of the spacer 21 with respect to the window supporting section 4 and the protective window 18 can be ensured.

The spacer 21 is disposed inside the window supporting section 4 in the state where its inner circumference surface is in contact with the outer circumference surface of the fiber probe 13, thus ensuring a stable condition of disposition without being shaky with respect to the fiber probe 13. Therefore, the high positional accuracy of the spacer 21 with respect to the fiber probe 13 and the protective window 18 can be ensured.

As described above, since the high positional accuracy of the spacer 21 is ensured, the positional accuracy of the space section 22 with respect to the fiber probe 13 and the protective window 18 increases, and the first abutting surface 24 of the space section 22 is brought into close contact with the distal end surface 13a of the fiber probe 13, as well as the second abutting surface 25 of the space section 22 is brought into close contact with the contact surface 19a of the protective window 18, making the distance between the distal end surface 13a and the contact surface 19a unlikely to change.

The first abutting surface 24 of the space section 22 is brought into close contact with the distal end surface 13a of the fiber probe 13 as well as the second abutting surface 25 of the space section 22 is brought into close contact with the contact surface 19a of the protective window 18, thereby positioning the optical fiber 17, the spacer 21, and the protective window 18 in the axial direction of the fiber probe 13 and allowing ensuring the high positional accuracy among the optical fiber 17, the spacer 21, and the protective window 18.

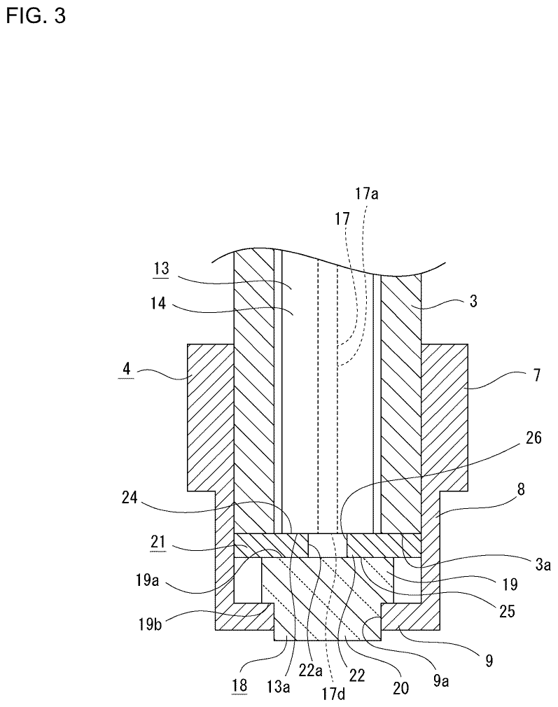

Note that the spacer 21 may include only the space section 22 (see FIG. 3). In this case, the pressing surface 3a of the shaft 3 is pressed against the upper surface of the outer circumference portion of the space section 22.

When the temperature sensor 1 configured as described above is mounted on a molding machine, such as an injection molding machine, and used to measure the temperature of a molten resin, infrared light passes through the transmission hole 22a of the spacer 21 from the protective window 18, enters the optical fiber 17, and is transmitted to the detector through the optical fiber 17, thereby measuring the temperature.

Note that while an example in which the elastic member 16 is provided to bias the fiber probe 13 has been described above, it is also possible to configure the temperature sensor 1 without the elastic member 16.

### Action and the Like of Spacer

As described above, in the temperature sensor 1, the space section 22 of the spacer 21 is disposed between the fiber probe 13 and the protective window 18, and thus the space portion 22 maintains a certain distance between the distal end surface 13a of the fiber probe 13 and the contact surface 19a of the protective window 18 (see FIG. 1 and FIG. 2). Therefore, a certain distance is also maintained between the contact surface 19a of the protective window 18 and the incident surface 17d of the optical fiber 17 via an air layer 26.

In general, it has been known that optical interference (thin-film interference) may occur in the process of light passing through a thin film, as described, for example, in Japanese Unexamined Patent Application Publication No. 2011-141372 and Japanese Unexamined Patent Application Publication No. 2009-276398.

Optical interference is a natural phenomenon in which lights (light waves) that are reflected at interfaces on both sides of a thin film in its thickness direction interfere with each other to increase or decrease the intensity of the reflected light of a specific wavelength. Specifically, when light enters a thin film, reflection occurs at interfaces on both sides. When the thickness of the thin film is an odd multiple of a quarter wavelength of the light, both reflected lights interfere with and cancel each other. When the thickness of the thin film is an odd multiple of a half wavelength of the light, both reflected lights increase their mutual intensities. These phenomena are referred to as optical interference.

Optical interference similarly occurs even when the thin film is an air layer, and optical interference may occur due to the reflection of light at one interface and the other interface of the air layer.

Such optical interference occurs when the thickness of the thin film (air layer) is extremely small and becomes less likely to occur as the thickness increases. For example, it may occur when the thickness range is on the order of nanometers (nm) to micrometers (μm), for example, at a thickness of 1 μm or less, but hardly occurs at a thickness range exceeding this.

In the meantime, the temperature sensor 1 is provided with the spacer 21, but on the contrary, in a configuration in which the contact surface 19a of the protective window 18 is in contact with the incident surface 17d of the optical fiber 17 without the spacer 21, from a microscopic viewpoint, due to minute roughness on the contact surface 19a and the incident surface 17d, an air layer (air gap) with a minute thickness on the order of nanometers (nm) to micrometers (μm) exists between them.

As described above, optical interference occurs when the thickness of the air layer is extremely small, and thus, in a configuration in which an air layer with such a minute thickness exists, optical interference may occur when infrared light enters the incident surface 17d and affect measurement results. The thickness of the air layer between the contact surface 19a and the incident surface 17d may vary depending on the pressure exerted on the protective window 18 by the molten resin or the like, and changes in the thickness of the air layer may also change the degree of optical interference or the like to cause fluctuations (variations) in measurement results.

In contrast, in the temperature sensor 1, the spacer 21 is disposed between the fiber probe 13 and the protective window 18, and thus a certain distance is maintained between the contact surface 19a of the protective window 18 and the incident surface 17d of the optical fiber 17 via the air layer 26 (transmission hole 22a). Since the spacer 21 is a structural object, the thickness of the air layer 26 is not on the order of nanometers or micrometers but on the order of millimeters (mm) or more.

Specifically, for the temperature sensor 1, the thickness of the air layer 26 (thickness of the space section 22) is, for example, 1 mm or more.

As described above, in the temperature sensor 1, the spacer 21 is disposed between the fiber probe 13 and the protective window 18, and infrared light passes through the transmission hole 22a and enters the incident surface 17d of the optical fiber 17, and thus the space section 22 maintains a certain distance or more between the optical fiber 17 and the protective window 18 to ensure stable measurement by suppressing the occurrence of optical interference.

Note that the thickness of the space section 22 is not limited to 1 mm or more as long as it is thick enough to ensure a certain level or more of strength and may be, for example, 0.5 mm or more or may be less than 0.5 mm as long as it is thick enough to ensure sufficient strength and does not cause optical interference.

In addition, since the air layer 26 is thick enough, even when the thickness of the air layer 26 slightly changes due to the pressure of the molten resin or the like, the rate of change is extremely small, and even when the slight change in the thickness of the air layer 26 causes optical interference, fluctuations (variations) in the measurement results of the temperature sensor 1 are unlikely to occur.

Further, in the temperature sensor 1, the spacer 21 is provided with the tubular section 23 that is continuous with the outer circumference portion of the space section 22, the distal end surface of the tubular section 23 is formed as the pressed surface 23a, and the pressing surface 3a of the shaft 3 is pressed against the pressed surface 23a.

Therefore, since the pressure of the molten resin is transmitted from the protective window 18 to the shaft 3 via the space portion 22 and the tubular section 23 of the spacer 21, and the pressure of the molten resin on the optical fiber 17 is suppressed, the load due to the pressure of the molten resin on the protective window 18 can be reduced, and the optical fiber 17 can be protected. In particular, since a load is unlikely to be applied to the bent section 17b of the optical fiber 17, the degree of bending of the bent section 17b is unlikely to change, thereby reducing the impact of the pressure of the molten resin on the measurement results of the temperature sensor 1.

Furthermore, a portion of the protective window 18 that is in contact with the space section 22 is provided as the contact section 19 having a columnar shape, and the diameter of the contact section 19 is equal to or greater than the diameter of the fiber probe 13.

Therefore, since the contact section 19 having a diameter greater than the diameter of the fiber probe 13 is brought into contact with the space section 22, the pressure of the molten resin is easily dispersed and transmitted from the protective window 18 to the shaft 3 via the space section 22 and the tubular section 23 of the spacer 21, and the load due to the pressure of the molten resin on the protective window 18 can be further reduced.

In addition, the elastic member 16 is provided to bias the fiber probe 13 in a direction of pressing the fiber probe 13 against the space section 22. Therefore, in a state where the load due to the pressure of the molten resin is transmitted from the protective window 18 to the fiber probe 13 via the space section 22, the fiber probe 13 is displaced in a direction that reduces the load against the biasing force of the elastic member 16, thereby protecting the fiber probe 13.

In particular, when the load due to the pressure of the molten resin is transmitted from the protective window 18 to the fiber probe 13 via the space portion 22, the fiber probe 13 is displaced in the direction that reduces the load against the biasing force of the elastic member 16, and thus the pressure of the molten resin is easily transmitted from the protective window 18 to the shaft 3 via the space section 22 and the tubular section 23 of the spacer 21. Therefore, the load due to the pressure of the molten resin on the optical fiber 17 and the load due to the pressure of the molten resin on the protective window 18 can be reduced at the same time.

### DESCRIPTION OF REFERENCE NUMERALS

1 temperature sensor
2 outer casing
3 shaft
13 fiber probe
16 elastic member
17 optical fiber
18 protective window
19 contact section
21 spacer
22 space section
22a transmission hole
23 tubular section

1. A temperature sensor used in a molding machine, comprising:
a tubular fiber probe into which an optical fiber is threaded;
an outer casing having a shaft into which the fiber probe is inserted;
a protective window that is located on a distal end side of the fiber probe and is formed of glass; and
a spacer that is disposed between the fiber probe and the protective window and has a space section both sides of which are in contact with the fiber probe and the protective window, wherein
the space section has a transmission hole formed to serve as a path leading infrared light to the optical fiber, and a diameter of the transmission hole is equal to or greater than an outer diameter of the optical fiber.

2. The temperature sensor according to claim 1, wherein
the spacer is provided with a tubular section that is continuous with an outer circumference portion of the space section, and
a distal end surface of the tubular section is pressed against one end surface of the shaft in its axial direction.

3. The temperature sensor according to claim 2, wherein
an outer circumference surface of the tubular section is in contact with an inner circumference surface of the outer casing.

4. The temperature sensor according to claim 2, wherein
a portion of the protective window in contact with the space section is provided as a columnar contact section, and
a diameter of the contact section is equal to or greater than a diameter of the fiber probe.

5. The temperature sensor according to claim 1, wherein
an elastic member that biases the fiber probe in a direction of pressing the fiber probe against the space section is provided.
